(19) United States
(12) Patent Application Publication
(10) Pub. No.: US 2011/0227401 A1
(43) Pub. Date: Sep. 22, 2011

(54) HUB ASSEMBLY

(76) Inventor: STEPHEN HUANG, TAICHUNG COUNTY (TW)

(21) Appl. No.: 12/728,619

(22) Filed: Mar. 22, 2010

(51) Int. Cl. B60B 27/00

(52) U.S. Cl. 301/110.5

(57) ABSTRACT

A hub assembly includes a tube having a fist connection portion on each of two ends thereof and each first connection portion has multiple first flat surfaces. Two flange parts are respectively connected to the two ends of the tube and each have a connection part and a second connection portion on two opposite sides thereof. The second connection portion includes an extension part and a groove is defined between the extension part and the flange part. The extension part is shaped to be inserted into the first connection portion corresponding thereto. A tubular member extends through the connection part and the second connection portion of each of the two flange parts. At least one bearing is located between the two flange parts and the tubular member. Two end rings are respectively connected to the connection parts.

### FIELD OF THE INVENTION

The present invention relates to a hub, and more particularly, to a hub composed of multiple parts and the connection of the parts is secure.

### BACKGROUND OF THE INVENTION

A conventional bicycle or motorcycle hub generally includes a tube with two flanges extending from two ends of the tube, an axle extends through the tube and is supported to the chainstays or front forks, two bearings are connected between the tube and the axle, and spokes are connected between the flange parts of the hub and the rims of the wheels. The wheels are rotatable relative to the hubs so as to move the bicycle or motorcycle forward.

One of the conventional hubs is an integral part which includes the tube and the flange parts. The connection between the flange parts and the tube is strong, but more machining processes are needed to the flange parts.

Another convention hub is assembled by the tube and the two flange parts, wherein the tube includes protrusions on two ends thereof and each of the flange parts includes recesses with which the protrusions are engaged. Two locking rings are threadedly connected to the two ends of the tube to lock the two flange parts to the tube.

Yet another convention hub includes a tube which includes multiple flat surfaces defined in an inner periphery of each end of the tube, and two flange parts each have a connection portion which is shaped to match with the flat surfaces of the tube such that the flange parts can be connected to the tube.

The first convention hub includes protrusions and recesses which require multiple steps of machining and may have less precision. The second and third conventional hubs can be assembled but cannot be connected securely.

The present invention intends to provide a hub assembly that is easily assembled while has better connection between parts.

### SUMMARY OF THE INVENTION

The present invention relates to a hub assembly which comprises a tube having a fist connection portion on each of two ends thereof and each first connection portion has multiple first flat surfaces. Two flange parts are respectively connected to the two ends of the tube and each have holes defined therethrough so as to be connected with spokes. Each flange part includes a connection part and a second connection portion on two opposite sides thereof. The second connection portion includes an extension part extending in a direction opposite to the connection part. A groove is defined between the extension part and the flange part. The two ends of the tube are engaged with the two grooves. The extension part has an outer surface that is inserted into the first connection portion corresponding thereto. A tubular member extends through the connection part and the second connection portion of each of the two flange parts. At least one bearing is located between each of the two flange parts and the tubular member. Two end rings are respectively connected to the connection parts.

The primary object of the present invention is to provide a hub assembly wherein the contact area between the tube and the two flange parts are large, thereby enhancing the connection between the tube and the two flange parts.

A second object of the present invention is to provide a hub assembly wherein the two ends of the tube can be engaged with two grooves in the two flange parts so that the two flange parts can be secured to the tube.

A third object of the present invention is to provide a hub assembly wherein the tube can be made of carbon fibers or Aluminum which is light and the hub assembly is easily assembled.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the hub assembly of the present invention;

FIG. 2 is an exploded view to show the hub assembly of the present invention;

FIG. 3 is a cross sectional view to show the hub assembly of the present invention, and

FIG. 4 shows an end cross sectional view of the hub assembly of the present invention.

### DETAILED DESCRIPTION OF THE PREFERRED EMBODIMENT

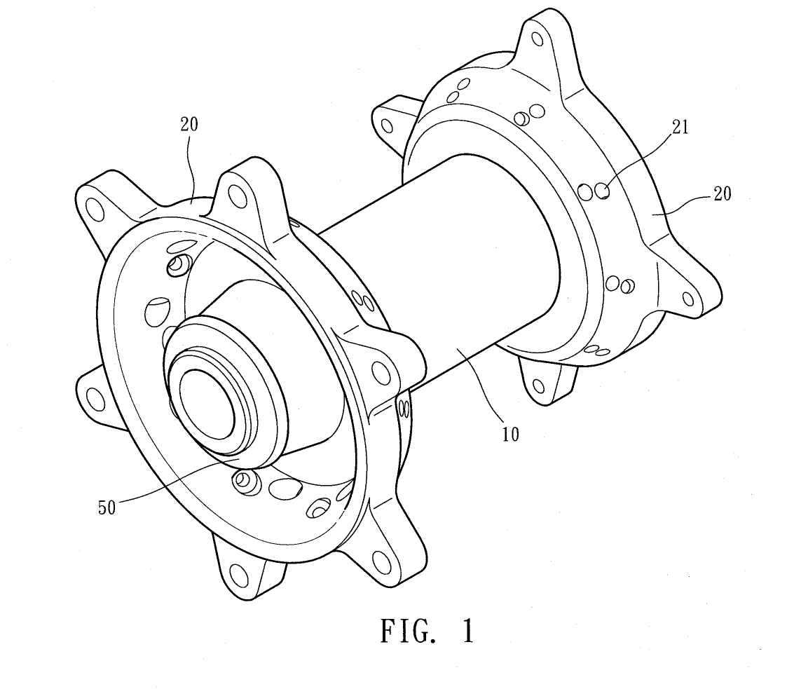

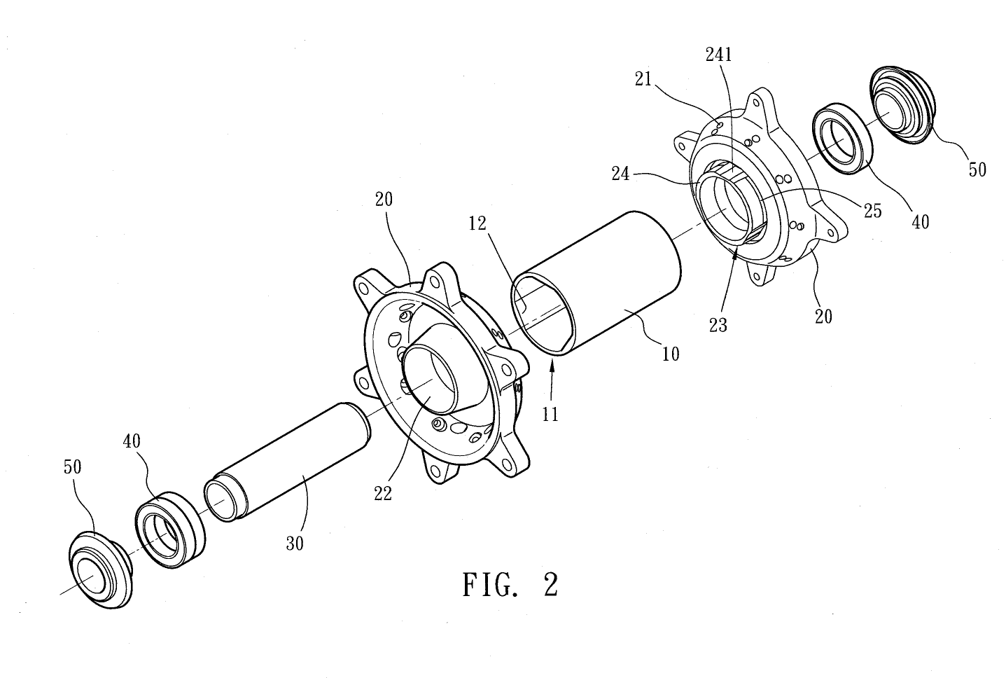

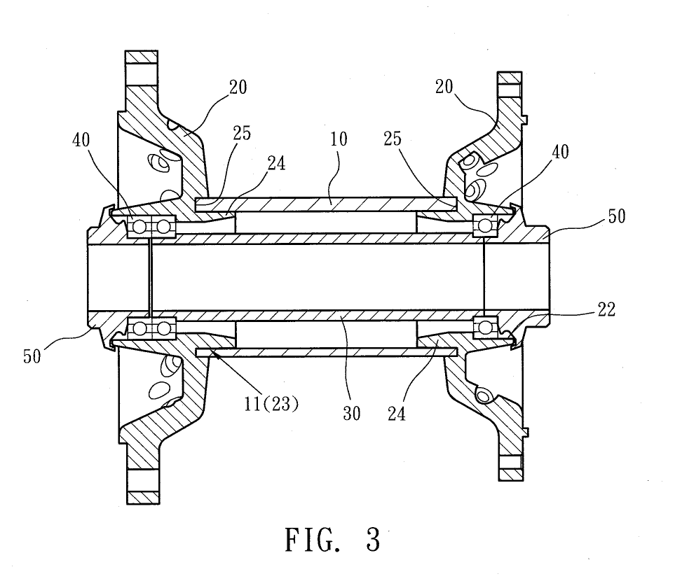

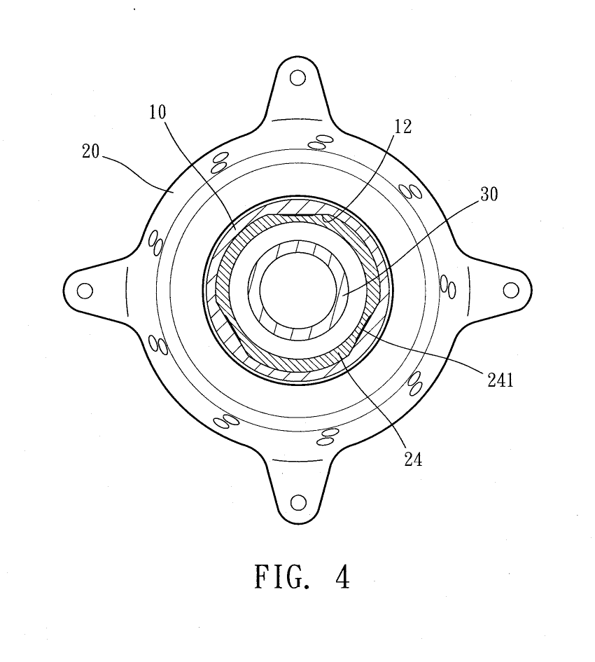

Referring to FIGS. 1 to 4, the hub assembly of the present invention comprises a tube 10 having a fist connection portion 11 on each of two ends thereof and each first connection portion 11 includes three first flat surfaces 12 defined in an inner periphery thereof. The thickness of each of the three flat surfaces 12 is thicker than a thickness of the tube 10. The tube 10 is made of carbon fibers, Aluminum or other material that is light in weight.

Two flange parts 20 are respectively connected to the two ends of the tube 10 and each have holes 21 defined therethrough so as to be connected with spokes which are not shown. Each flange part 20 has a connection part 22 and a second connection portion 23 on the center of two opposite sides thereof. The second connection portion 22 includes an extension part 24 extending in a direction opposite to the connection part 22 and a groove 25 is defined between the extension part 24 and the flange part 20. The extension part 24 has an outer surface that is inserted into the first connection portion corresponding thereto. In particular, there are three second flat surfaces 241 on the outer surface of the extension part 24 such that the extension part 24 can be inserted in the first connection portion 11 and does not rotate relative to the first connection portion 11. The two ends of the tube 10 are engaged with the two grooves 25.

A tubular member 30 extends through the connection part 22 and the second connection portion 23 of each of the two flange parts 20. A bearing 40 is located between each of the two flange parts 20 and the tubular member 30. Two end rings 50 are respectively connected to the connection parts 22.

It is noted that the two connection portions 11 of the two ends of the tube 10 extend through the second connection portions 23 of the flange parts 20, and the tow ends of the tube 10 are engaged with the grooves 25, so that the contact area between the flange parts 20 and the tube 10 is large enough to provide secure connection therebetween. The first connection portions 11 and the second portions 23 are engaged with each other by the engagement of the first and second flat surfaces 12, 241 further ensures the connection between the tube 10 and the flange parts 20. The grooves 25 make the installation of the tube 10 be easy and efficient.

The hub assembly is assembled by multiple parts which are connected firmly by larger contact area and the assembling is easy and finished within a short period of time.

While we have shown and described the embodiment in accordance with the present invention, it should be clear to those skilled in the art that further embodiments may be made without departing from the scope of the present invention.

What is claimed is:

1. A hub assembly comprising:
a tube having a fist connection portion on each of two ends thereof and each first connection portion having multiple first flat surfaces;
two flange parts respectively connected to the two ends of the tube and each having holes defined therethrough, each flange part having a connection part and a second connection portion on two opposite sides thereof, the second connection portion having an extension part extending in a direction opposite to the connection part, a groove defined between the extension part and the flange part, the extension part having an outer surface that is inserted into the first connection portion corresponding thereto, the two ends of the tube being engaged with the two grooves;
a tubular member extending through the connection part and the second connection portion of each of the two flange parts, at least one bearing located between each of the two flange parts and the tubular member, and
two end rings respectively connected to the connection parts.

2. The hub assembly as claimed in claim 1, wherein there are at least two first flat surfaces defined in an inner periphery of each of the first connection portions.

3. The hub assembly as claimed in claim 2, wherein a thickness of each of the at least two flat surfaces is thicker than a thickness of the tube.

4. The hub assembly as claimed in claim 1, wherein the tube is made of carbon fibers.

5. The hub assembly as claimed in claim 1, wherein the tube is made of Aluminum.
